(19) United States
(12) Patent Application Publication
(10) Pub. No.: US 2019/0168875 A1
(43) Pub. Date: Jun. 6, 2019

(54) Flying Power-Washing Drone

(71) Applicant: LUCID DRONE TECHNOLOGIES, INC., DAVIDSON, NC (US)

(72) Inventors: Andrew McGuff Ashur, Vienna, VA (US); David Michael Danielson, JR., Tampa, FL (US); Adrian Harry Mayans, Miami, FL (US)

(21) Appl. No.: 16/212,679

(22) Filed: Dec. 6, 2018

Related U.S. Application Data
(60) Provisional application No. 62/595,038, filed on Dec. 5, 2017.

(51) Int. Cl. B64D 1/18; B08B 3/02; B64C 39/02

(52) U.S. Cl. CPC B64D 1/18; B08B 3/024; B64C 2201/12; B08B 2203/02; B64C 39/024

(57) ABSTRACT

A drone cleaning apparatus includes a drone; and a pressure washer or power washer comprising a wand with nozzle, hose, and motor unit. The wand is fastened to an underside of the drone, with the hose attached to and connecting the wand and the motor unit. When the motor unit is turned on, a liquid jet emanates from the nozzle of the wand and may be directed onto a building for cleaning of the building. A method of making the drone cleaning apparatus, comprises: providing a drone and a pressure washer or power washer comprising a wand with nozzle, hose, and motor unit; attaching the wand to a bottom of the drone; and connecting the hose to the wand and to the motor unit.

### CROSS-REFERENCE TO RELATED APPLICATION

The present application is a U.S. nonprovisional patent application of, and claims priority under 35 U.S.C. § 119(e) to, U.S. provisional patent application 62/595,038, filed Dec. 5, 2017, the disclosure of which is hereby incorporated herein by reference.

### COPYRIGHT STATEMENT

Any new and original work of authorship in this document is subject to copyright protection under the copyright laws of the United States and other countries. Reproduction by anyone of this document as it appears in official governmental records is permitted, but otherwise all other copyright rights whatsoever are reserved.

### BACKGROUND OF THE INVENTION

The present invention generally relates to drone systems, apparatus, and methods for dispensing liquid solutions, such as liquid cleaning solutions for cleaning exteriors of structures including windows, walls, and roofs. Such structures may include multistory residential homes as well as commercial, educational, athletic, governmental, and institutional buildings such as skyscrapers, halls, gymnasiums, and monuments.

Unmanned Aerial Vehicles (UAVs), or simply “drones”, have been used in a variety of ways for many years, such as for the purposes of photography, surveying, military operations, etc. In many ways, especially with regards to inspection and surveying, drones have allowed for a safer, more efficient way to perform tasks that were previously difficult and dangerous. With regards to cleaning, and specifically the cleaning of multistoried building exteriors, dangerous, inefficient, and expensive equipment is generally required. Ladders, lifts, scaffolds, and other related equipment that allow for human workers to clean above ground present a number of liability concerns, as a multitude of accidents and deaths occur each year from workers using such equipment.

Drone systems, apparatus, and methods are disclosed, for example, in the following U.S. patent references: U.S. Pat. Nos. 10,011,352; 9,611,038; U.S. patent application Ser. No. 14/674,524; U.S. Patent Appl. Publ. 2017/0340176; U.S. Patent Appl. Publ. 2017/0305547; U.S. Patent Appl. Publ. 2017/0158329; U.S. Patent Appl. Publ. 2016/0082460; U.S. Patent Appl. Publ. 2015/02742941; U.S. Patent Appl. Publ. 2013/0134254; and, U.S. Patent Appl. Publ. 2009/0205845.

While the foregoing known systems, apparatus, and methods and suitable for their intended purposes, it is believed that continued improvements in drone systems, apparatus, and methods for dispensing liquid solutions is desirable. One or more aspects and features of the present invention are believed to provide such improvement.

### SUMMARY OF THE INVENTION

The present invention includes many aspects and features. Moreover, while many aspects and features relate to, and are described in, the context of cleaning, it will be appreciated that other aspects and features of the invention are also applicable in other contexts as well.

In accordance with an aspect of the invention, a drone cleaning apparatus comprises: a drone; and an apparatus for generating a high pressure liquid jet comprising a wand with nozzle, hose, and motor unit; wherein the wand is fastened to an underside of the drone with the hose attached to and connecting the wand and the motor unit, whereby a liquid jet emanating from the nozzle of the wand may be directed for cleaning of a building structure by flying the drone while the motor unit is turned on.

In a feature, the apparatus for generating the high pressure liquid jet is a pressure washer.

In a feature, the apparatus for generating the high pressure liquid jet is a power washer.

In accordance with another aspect of the invention, a method of making a drone cleaning apparatus, comprises the steps of: providing a drone and an apparatus for generating a high pressure liquid jet comprising a wand with nozzle, hose, and motor unit; attaching the wand to a bottom of the drone; and connecting the hose to the wand and to the motor unit.

In accordance with another aspect of the invention, a method of cleaning a building, comprises the steps of: providing a drone and an apparatus for generating a high pressure liquid jet comprising a wand with nozzle, hose, and motor unit; attaching the wand to a bottom of the drone; connecting the hose both to the wand and to the motor unit; and flying the drone within a vicinity of the building while the motor unit is turned on such that a jet of liquid issues from the nozzle of the wand onto the building.

In addition to the aforementioned aspects and features of the present invention, it should be noted that the present invention further encompasses the various logical combinations and subcombinations of such aspects and features. Thus, for example, claims in this or a divisional or continuing patent application or applications may be separately directed to any aspect, feature, or embodiment disclosed herein, or combination thereof, without requiring any other aspect, feature, or embodiment.

### BRIEF DESCRIPTION OF THE DRAWINGS

One or more preferred embodiments of the present invention now will be described in detail with reference to the accompanying drawings.

FIG. 1 is a view of an embodiment of a drone system for dispensing liquid solutions in accordance with one or more aspects and features of the invention.

FIG. 2 is a view of the drone of FIG. 1 while in flight.

FIG. 3 is a view of the drone of FIG. 1 in flight and being used by an operator to clean a side of a building.

### DETAILED DESCRIPTION

As a preliminary matter, it will readily be understood by one having ordinary skill in the relevant art (“Ordinary Artisan”) that the invention has broad utility and application. Furthermore, any embodiment discussed and identified as being “preferred” is considered to be part of a best mode contemplated for carrying out the invention. Other embodiments also may be discussed for additional illustrative purposes in providing a full and enabling disclosure of the invention. Furthermore, an embodiment of the invention may incorporate only one or a plurality of the aspects of the invention disclosed herein; only one or a plurality of the features disclosed herein; or combination thereof. As such, many embodiments are implicitly disclosed herein and fall within the scope of what is regarded as the invention.

Accordingly, while the invention is described herein in detail in relation to one or more embodiments, it is to be understood that this disclosure is illustrative and exemplary of the invention and is made merely for the purposes of providing a full and enabling disclosure of the invention. The detailed disclosure herein of one or more embodiments is not intended, nor is to be construed, to limit the scope of patent protection afforded the invention in any claim of a patent issuing here from, which scope is to be defined by the claims and the equivalents thereof. It is not intended that the scope of patent protection afforded the invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the invention. Accordingly, it is intended that the scope of patent protection afforded the invention be defined by the issued claim(s) rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

With regard solely to construction of any claim with respect to the United States, no claim element is to be interpreted under 35 U.S.C. 112(f) unless the explicit phrase “means for” or “step for” is actually used in such claim element, whereupon this statutory provision is intended to and should apply in the interpretation of such claim element. With regard to any method claim including a condition precedent step, such method requires the condition precedent to be met and the step to be performed at least once during performance of the claimed method.

Furthermore, it is important to note that, as used herein, “comprising” is open-ended insofar as that which follows such term is not exclusive. Additionally, “a” and “an” each generally denotes “at least one” but does not exclude a plurality unless the contextual use dictates otherwise. Thus, reference to “a picnic basket having an apple” is the same as “a picnic basket comprising an apple” and “a picnic basket including an apple”, each of which identically describes “a picnic basket having at least one apple” as well as “a picnic basket having apples”; the picnic basket further may contain one or more other items beside an apple. In contrast, reference to “a picnic basket having a single apple” describes “a picnic basket having only one apple”; the picnic basket further may contain one or more other items beside an apple. In contrast, “a picnic basket consisting of an apple” has only a single item contained therein, i.e., one apple; the picnic basket contains no other item.

When used herein to join a list of items, “or” denotes “at least one of the items” but does not exclude a plurality of items of the list. Thus, reference to “a picnic basket having cheese or crackers” describes “a picnic basket having cheese without crackers”, “a picnic basket having crackers without cheese”, and “a picnic basket having both cheese and crackers”; the picnic basket further may contain one or more other items beside cheese and crackers.

When used herein to join a list of items, “and” denotes “all of the items of the list”. Thus, reference to “a picnic basket having cheese and crackers” describes “a picnic basket having cheese, wherein the picnic basket further has crackers”, as well as describes “a picnic basket having crackers, wherein the picnic basket further has cheese”; the picnic basket further may contain one or more other items beside cheese and crackers.

The phrase “at least one” followed by a list of items joined by “and” denotes an item of the list but does not require every item of the list. Thus, “at least one of an apple and an orange” encompasses the following mutually exclusive scenarios: there is an apple but no orange; there is an orange but no apple; and there is both an apple and an orange. In these scenarios if there is an apple, there may be more than one apple, and if there is an orange, there may be more than one orange. Moreover, the phrase “one or more” followed by a list of items joined by “and” is the equivalent of “at least one” followed by the list of items joined by “and”.

Additionally, “power washer” and “pressure washer” mean an apparatus for producing a high-pressure jet of liquid, wherein the power washer differs over the pressure washer by further heating the liquid. Both have a motor unit, hose, and wand with nozzle from which the high-pressure jet of liquid is directed.

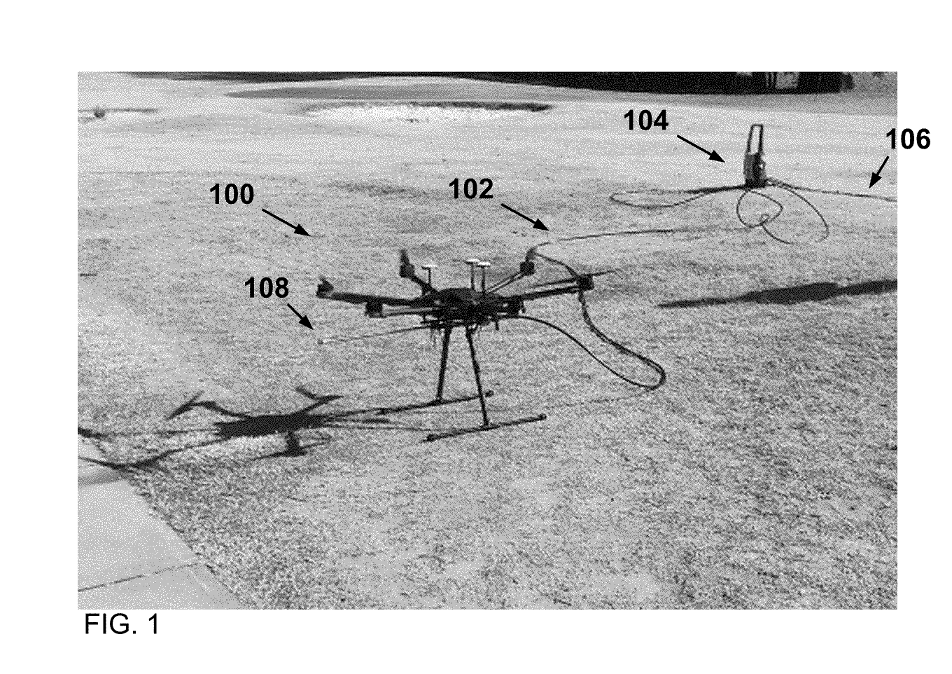

Referring now to FIGS. 1-3, an embodiment of a drone system for dispensing liquid solutions in accordance with one or more aspects and features of the invention is described.

In particular, FIG. 1 illustrates the system, which comprises a drone 100 and pressure washer. The pressure washer comprises a wand 108 having a nozzle 110, a hose 102, and a motor unit 104, with the hose connecting the wand and the motor unit. Another hose 106 connects the motor unit 104 to a source of a liquid solution (not shown). When turned on, the motor unit generates the pressure for creating the high-pressure jet of the liquid from the nozzle of the wand. No trigger or valve at the wand controls the flow, the high-pressure jet of liquid being controlled by the turning of the motor unit on and off.

Rather than a pressure washer, a power washer likewise may be used. In this alternative, the liquid is heated.

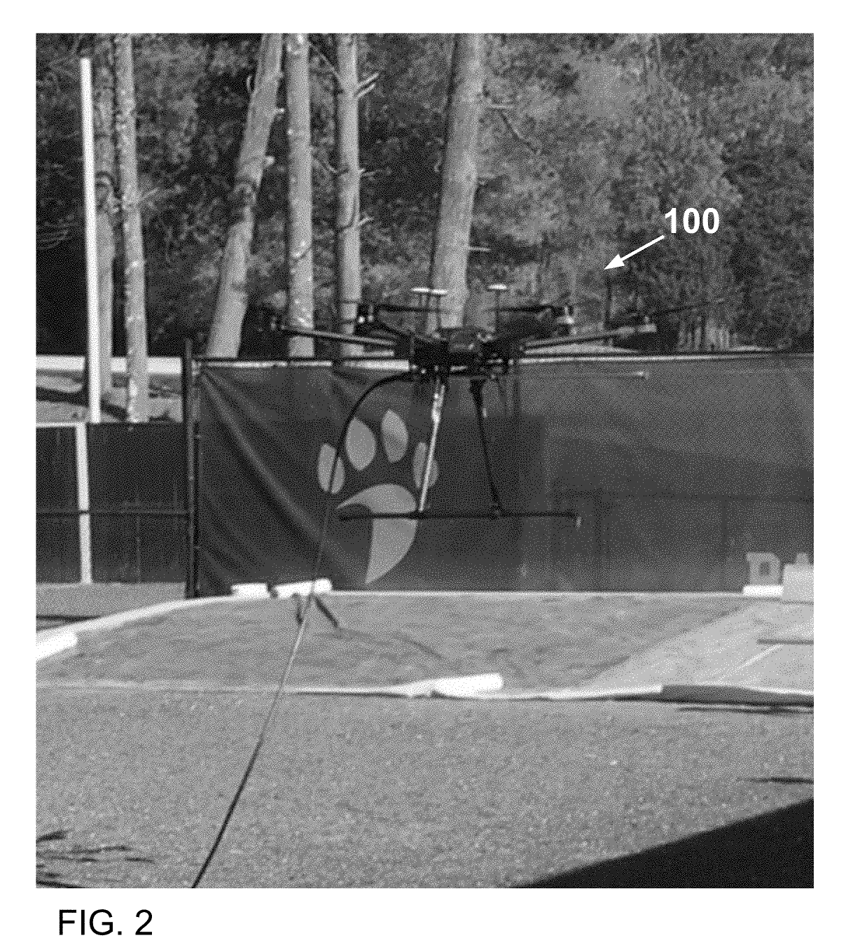

FIG. 2 is a view of the drone 100 while in flight following takeoff.

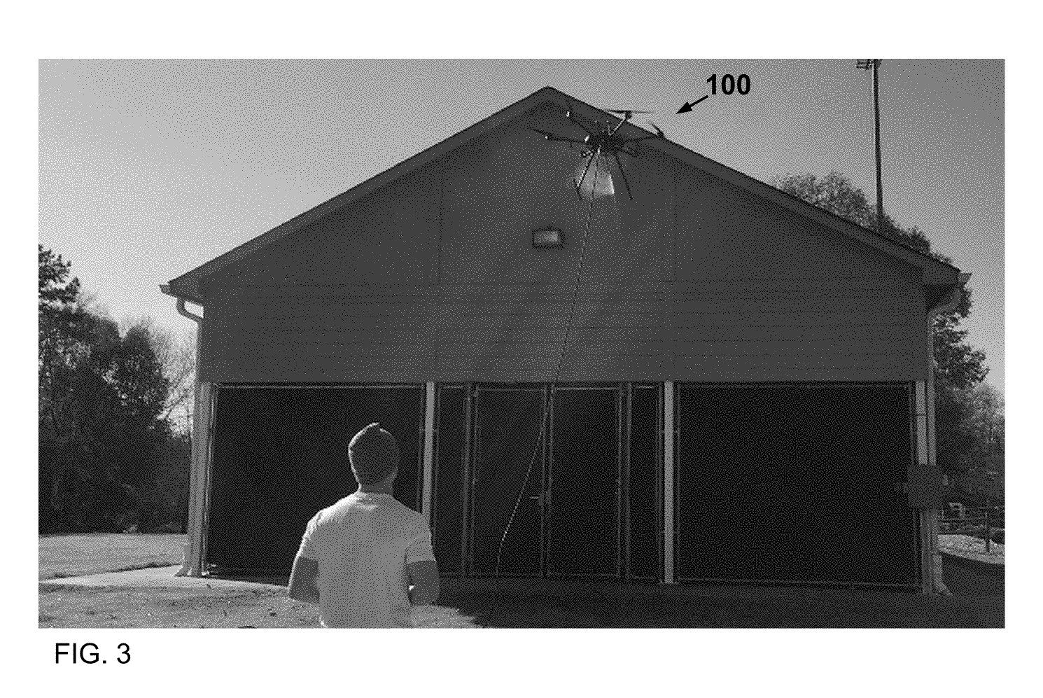

FIG. 3 is a view of the drone 100 in flight and being used by an operator to clean a side of a building. The drone 100 is controllable and able to counteract the force of the water generated by the power washer in order to clean the desired target area. It will be appreciated that the drone 100 is able to maintain a stable flight while the power washer 104 is on and operating, even at high pressures. Also, the drone is wirelessly controlled using a drone controller (not shown). The controller may comprise a radio transmitter or transceiver. The system of FIG. 1 is being used, wherein the hose 106 has been attached to a tank containing a cleaning solution for cleaning the side of the building. Following application of the cleaning solution, the hose 106 preferably is attached to an outdoor spigot or faucet of the building for rinsing of the cleaning solution from the side of the building.

The drone system allows for an array of cleaning applications due to the flying capabilities of the drone 100. With the versatility that comes with a flying drone, the cleaning of upper level windows, siding, concrete, brick, gutters, and other hard to reach places, surfaces, objects, and structures becomes more accessible. This system thus is able to take the place of many cleaning processes that are currently manually performed, such as but not limited to the window washing of multistory buildings or other tall structures. It is believed that this drone system will help reduce the number of injuries and deaths of window washer caused each year because of the occupational hazards associated with washing upper-level windows. Preferably, window washers will no longer need to be suspended on platforms that scale the side of buildings.

The drone system is constructed using a drone and a power washer or pressure washer. Preferably, the wand of the power washer or pressure washer is securely fastened to the underside of the body of the drone. The wand then is attached to one end of the hose of the power washer or pressure washer, with the other end of the hose being attached to the motor unit. The trigger is omitted or rendered in an open or on position for free flow of the pressurized liquid through the hose into the wand and out of the nozzle. The power washer or pressure washer also is connected to a water source. By having only wand of the power washer or pressure washer attached to the drone, the drone has a considerable degree of versatility in terms of its flying capacity. The drone further has a flying range that is equal to the length of the hose in extending from the power washer or pressure washer. Moreover, an extension cord hose may be utilized to increase the flying range, if desired, if the standard hose length of the particular pressure washer that is used is insufficient.

After the wand is attached to the body of the drone and then connected to the hose, which is connected to the power washer, the drone itself is turned on. Following takeoff and subsequent flight of the drone, the water source and power washer or pressure washer are turned on, ultimately leading to a pressurized jet of liquid emanating from the nozzle of the wand. The pressurized jet of liquid is directed for cleaning by moving the drone up, down, left, and right, as desired.

The flying, power-washing drone has a variety of advantages over other means of cleaning. Firstly, the drone has tremendous versatility, as it can fly in an array of directions in order to reach places that are traditionally hard to reach. Secondly, the invention utilizes a design that allows the minimum amount of weight to be attached to the drone in order to provide great flight versatility. Thirdly, the wand of the power washer or pressure washer is securely fastened to the drone and can effectively clean various surfaces and structures. These are merely a few examples of the host of advantages that the flying, power-washing drone provides.

Based on the foregoing description, it will be readily understood by those persons skilled in the art that the present invention has broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention. Accordingly, while the present invention has been described herein in detail in relation to one or more preferred embodiments, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements, the present invention being limited only by the claims appended hereto and the equivalents thereof.

What is claimed is:

1. A drone cleaning apparatus, comprising:
(a) a drone; and
(b) a pressure washer or power washer comprising a wand with nozzle, hose, and motor unit;
(c) wherein the wand is fastened to an underside of the drone with the hose attached to and connecting the wand and the motor unit, whereby a liquid jet emanating from the nozzle of the wand may be directed for cleaning of a building structure by flying the drone while the motor unit is turned on.

2. A method of making a drone cleaning apparatus, comprising the steps of:
(a) providing (i) a drone and (ii) a pressure washer or power washer comprising a wand with nozzle, hose, and motor unit;
(b) attaching the wand to a bottom of the drone; and
(c) connecting the hose to the wand and to the motor unit.

3. A method of cleaning a building, comprising the steps of:
(a) providing (i) a drone and (ii) a pressure washer or power washer comprising a wand with nozzle, hose, and motor unit;
(b) attaching the wand to a bottom of the drone;
(c) connecting the hose both to the wand and to the motor unit; and
(d) flying the drone within a vicinity of the building while the motor unit is turned on such that a jet of liquid issues from the nozzle of the wand onto the building.
